(19) United States
(12) Patent Application Publication
(10) Pub. No.: US 2021/0370331 A1
(43) Pub. Date: Dec. 2, 2021

(54) COATING APPARATUS

(71) Applicants: ORDOS YUANSHENG OPTOELECTRONICS CO., LTD., Ordos, Inner Mongolia (CN); BOE TECHNOLOGY GROUP CO., LTD., Beijing (CN)

(72) Inventors: Zehua WANG, Beijing (CN); Naisheng LI, Beijing (CN); Zhuo CHEN, Beijing (CN); Yonghui WEI, Beijing (CN)

(21) Appl. No.: 16/339,783

(22) PCT Filed: Sep. 30, 2018
(86) PCT No.: PCT/CN2018/109029

§ 371 Date: Apr. 5, 2019

(30) Foreign Application Priority Data
Oct. 11, 2017 (CN) 201710942980.0

(51) Int. Cl. B05B 13/04; B05B 15/68; B05B 13/02

(52) U.S. Cl. CPC B05B 13/0421; B05B 13/0278; B05B 15/68

(57) ABSTRACT

A coating apparatus includes: a nozzle, having a spraying direction; and a rotation part, having a rotation axis, the rotation part being connected with the nozzle to drive the nozzle to rotate around the rotation axis. The spraying direction and an extension direction of the rotation axis are not perpendicular to each other.

The present application claims the benefits of Chinese patent application No. 201710942980.0, which was filed on Oct. 11, 2017 and is fully incorporated herein by reference as part of the embodiments of this application.

### TECHNICAL FIELD

The present disclosure relates to a coating apparatus.

### BACKGROUND

Coating process of sealant is a significate step in a manufacturing process of liquid crystal panel. A color filter substrate and an array substrate are bonded by coating sealant on the periphery of the panel, to form a liquid crystal cell in the panel. The thickness of the liquid crystal cell can also be controlled by controlling the coating amount of the sealant, and meanwhile, the sealant can also prevent the liquid crystal encapsulated in the liquid crystal cell from being polluted.

### SUMMARY

At least one embodiment of the present disclosure provides a coating apparatus, comprising: a nozzle, having a spraying direction; and a rotation part, having a rotation axis, the rotation part being connected with the nozzle to drive the nozzle to rotate around the rotation axis, wherein the spraying direction and an extension direction of the rotation axis are not perpendicular to each other.

In some examples, the nozzle is movably connected with the rotation part to allow a distance between the nozzle and the rotation axis to be adjustable.

In some examples, the spraying direction is parallel to the extending direction of the rotation axis.

In some examples, the coating apparatus further comprises a fixing stage, the rotation part being connected with the fixing stage.

In some examples, the coating apparatus further comprises a workbench, comprising a bearing surface for bearing a piece to be coated, and the rotation axis of the rotation part being perpendicular to the bearing surface of the workbench.

In some examples, the coating apparatus further comprises a first driving part, connected with the nozzle to drive the nozzle to move in a direction perpendicular to the rotation axis, so as to change the distance between the nozzle and the rotation axis.

In some examples, the coating apparatus further comprises a second driving part, connected with at least one of the fixing stage and the workbench to allow the fixing stage to be movable relative to the workbench in a first direction and a second direction, the first direction and the second direction being perpendicular to each other and both perpendicular to the rotation axis.

In some examples, the first driving part comprises a first driving motor, the first driving motor comprises a first motor body and a rotatable first output shaft, the first motor body is fixedly connected with the rotation part, and the first output shaft is connected with the nozzle through a transmission mechanism.

In some examples, the transmission mechanism is a lead screw nut mechanism, the lead screw nut mechanism comprises a lead screw and a nut which are driven through threads, the lead screw extends in a direction perpendicular to the rotation axis and is connected with the first output shaft, the rotation part is provided with a guide part extending in a direction perpendicular to the rotation axis, the nut is in a sliding connection with the guide part, and the nozzle is fixedly connected with the nut.

In some examples, the nut has a threaded hole for fitting with the lead screw and a sliding hole for fitting with the guide part, and the sliding hole is at least partially sleeved on the guide part.

In some examples, the guide part has a sliding groove, the sliding hole is provided with a sliding rail therein, and the sliding rail being clamped into the sliding groove and being able to slide along the sliding groove.

In some examples, the transmission mechanism is a rack-pinion mechanism, and the rack-pinion mechanism comprises a pinion and a rack which are engaged with each other, the pinion is connected with the first output shaft, the rack extends in a direction perpendicular to the rotation axis, the rotation part is provided with a guide part extending in a direction perpendicular to the rotation axis, the rack is in sliding connection with the guide part, and the nozzle is fixedly connected with the rack.

In some examples, the transmission mechanism is a crank-slider mechanism, and the crank-slider mechanism comprises a crank and a slider which are engaged with each other, the crank is connected with the first output shaft, the slider extends in a direction perpendicular to the rotation axis, the rotation part is provided with a guide part extending in a direction perpendicular to the rotation axis, the slider is in sliding connection with the guide part, and the nozzle is fixedly connected with the slider.

In some examples, the coating apparatus further comprises a control element electrically connected to the first driving motor to control startup and shutdown of the first output shaft, the guide part being an optical scale, which is configured to read position information of the nozzle in real time and send the position information to the control element.

In some examples, the fixing stage is further provided with a work head, the rotation part is a rotation work disk, a center of the rotation part is connected with the work head, and the second driving part comprises: a second driving motor comprising a second motor body and a movable second output shaft, wherein the second motor body is fixedly connected with the fixing stage and the second output shaft is connected with the work head to drive the work head to move in the first direction; and a third driving motor comprising a third motor body and a rotatable third output shaft, wherein the third motor body is fixedly connected with the work head and the third output shaft is connected with the rotation part to drive the rotation part to rotate.

In some examples, the fixing stage is configured to be movable in the second direction, the second driving part further comprises a fourth driving motor, the fourth driving motor comprises a fourth motor body and a movable fourth output shaft, the fixing stage is a bar-shaped stage extending in the first direction, both ends of the fixing stage are respectively provided with a first guide rail perpendicular to the fixing stage and extending in the second direction, the fixing stage is in sliding connection with the first guide rail, and the fourth output shaft is connected with the first guide rail to drive the fixing stage to move.

In some examples, the workbench is configured to be movable in a second direction, and the driving part further includes a fifth driving motor comprising a fifth motor body and a movable fifth output shaft, a back surface of the workbench is provided with a second guide rail, the workbench is in sliding connection with the second guide rail, and the fifth output shaft is connected with the workbench to drive the workbench to move.

### BRIEF DESCRIPTION OF THE DRAWINGS

In order to more clearly illustrate the technical solutions of the embodiments of the present disclosure, accompanying drawings of the embodiments will be briefly described in the following. It is obvious that the accompanying drawings described in the following only relate to some embodiments of the present disclosure, and are not limitative of the present disclosure.

FIG. 1 is a schematic diagram of a coating apparatus for coating sealant according to an embodiment of the present disclosure;

FIG. 2 is a schematic assembly diagram of a rotation part, a nozzle and a transmission mechanism of a coating apparatus according to an embodiment of the present disclosure.

FIG. 3 is a schematic assembly diagram of a rotation part and a guide part of a coating apparatus according to an embodiment of the present disclosure.

FIG. 4 is a schematic view of a spraying part and a workbench of a coating apparatus according to an embodiment of the present disclosure.

FIG. 5 is an assembly schematic diagram of a fixing stage of a coating apparatus according to an embodiment of the present disclosure.

FIG. 6 is an assembly schematic diagram of a workbench of a coating apparatus according to an embodiment of the present disclosure.

FIG. 7 is a schematic diagram of the operation of a coating apparatus according to the embodiment of the present disclosure.

FIG. 8 is another schematic diagram of the operation of a coating apparatus according to the embodiment of the present disclosure.

### REFERENCE NUMERALS

100—Coating apparatus, 200—glass substrate, 300—panel, 10—workbench, 21—fixing stage, 22—rotation part, 23—nozzle, 24—transmission mechanism, 241—lead screw, 242—nut, 25—work head, 26—guide part, 261—sliding groove, 31—first driving motor, 32—second driving motor, 33—fourth driving motor, 34—fifth driving motor, 41—first guide rail, 42—second guide rail, X—first direction, Y—second direction.

### DETAILED DESCRIPTION

In order to make objects, technical details and advantages of the embodiments of the invention apparent, technical solutions according to the embodiments of the present invention will be described clearly and completely as below in conjunction with the accompanying drawings of embodiments of the present invention. It is to be understood that the described embodiments are only a part of but not all of exemplary embodiments of the present invention. Based on the described embodiments of the present invention, various other embodiments can be obtained by those of ordinary skill in the art without creative labor and those embodiments shall fall into the protection scope of the present invention.

A traditional sealant coating apparatus adopts a movable workbench, and achieves coating on a rectangular panel by controlling the movement of the workbench. However, with the development of wearable devices, a coating process of special-shaped sealant, especially a coating process of circular sealant, has become more and more in actual production. A coating process of existing circular panel is usually achieved through a combined control of the movement of the workbench in two directions, so that the coated sealant has a polygonal shape which is approximately circular, and the movement of the workbench in two directions needs to be accurately controlled, so that the control of the coating apparatus is more complicated. In particular, upon the shape to be coated being a combination of circular and rectangular shapes, the driving control of the coating apparatus is more complicated and the editing of programs is more difficult, resulting in a slow coating process of sealant, which seriously affects the utilization and productivity of production lines.

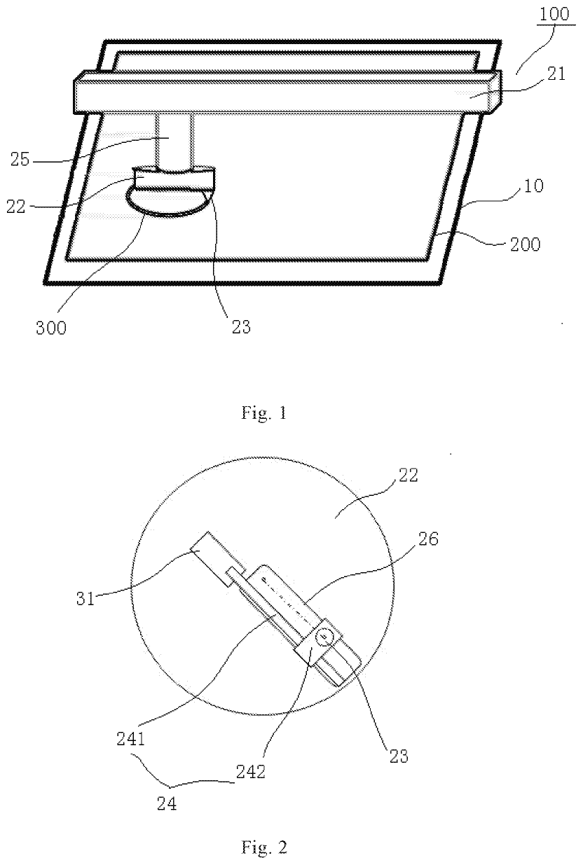

A coating apparatus 100 according to an embodiment of the present disclosure will be described below with reference to FIGS. 1 to 8.

As illustrated by FIG. 1, a coating apparatus 100 according to an embodiment of the present disclosure includes a workbench 10, a spraying part, and a driving part.

The workbench 10 is used for placing a glass substrate 200, and the spraying part includes a fixing stage 21, a rotation part 22 and a nozzle 23; the rotation part 22 is pivotally connected with the fixing stage 21 and a rotation axis of the rotation part 22 is perpendicular to a surface of the workbench 10, and the nozzle 23 is movably connected with the rotation part 22. The driving part is connected to the rotation part 22 to drive the rotation part 22 to rotate, and the driving part is connected with the nozzle 23 to drive the nozzle 23 to be movable in a radial direction of the rotation axis. The driving part is connected to at least one of the fixing stage 21 and the workbench 10 to allow the fixing stage 21 to be movable relative to the workbench 10 in a first direction X and a second direction Y, the first direction X and the second direction Y being perpendicular to each other and both perpendicular to an axial direction of the rotation axis.

The foregoing is only one embodiment according to the present disclosure, but embodiments according to the present disclosure are not limited thereto. For example, some embodiments of the present disclosure provide a coating apparatus including a nozzle having a spraying direction; a rotation part having a rotation axis, the rotation part being connected with the nozzle to drive the nozzle to rotate around the rotation axis, the spraying direction and an extension direction of the rotation axis are not perpendicular to each other. In the embodiments of the present disclosure, under the condition that the nozzle can be rotated by the rotation part, a coating process of circular sealant can be achieved. In addition, the spraying direction of the nozzle is not perpendicular to the rotation axis, so that a material can be sprayed in a direction parallel to the rotation axis for coating. In some embodiments, the spraying direction of the nozzle is parallel to the rotation axis. In addition, on the basis of the above-mentioned circular coating method, the coating process of sealant with various irregularly shapes can be performed in combination with linear movements of the fixing stage or the workbench in two directions. In addition, although the embodiments of the present disclosure are described by taking the coating of sealant as an example, the embodiments of the present disclosure are not limited thereto, and the coating apparatus according to the embodiments of the present disclosure may coat any other suitable materials.

As illustrated by FIG. 1 or 2, in a case where the rotation part 22 is disk-shaped, the rotation axis of the rotation part may be an axis line passing through a center of the rotation part and being perpendicular to a surface of the disk-shaped rotation part. The rotation axis here can be a virtual axis. Under the drive of the rotation part, the nozzle can rotate around the rotation axis.

“The driving part is connected with at least one of the fixing stage 21 and the workbench 10 to allow the fixing stage to be movable relative to the workbench 10 in a first direction X and a second direction Y” refers to that the driving part can drive at least one of the workbench 10 and the fixing stage 21 to move in the first direction X, and can drive at least one of the workbench 10 and the fixing stage 21 to move in the second direction Y. That is, the driving part is only required to be able to drive any one of the workbench 10 and the fixing stage 21 to achieve relative movement of the two in the first direction X and the second direction Y. At least one of the fixing stage 21 and the workbench 10 can be driven to move in the first direction X, and similarly at least one of the fixing stage 21 and the workbench 10 can be driven to move in the second direction Y.

In the coating apparatus 100 according to the embodiment of the present disclosure, by arranging the rotation part 22 on the fixing stage 21 and movably connecting the nozzle 23 to the rotation part 22, the fixing stage 21 and the workbench 10 can be relatively fixed upon the coating apparatus 100 being needed to coat a circular portion, a position of the nozzle 23 in the radial direction of the rotation part 22 can be adjusted according to the size of the circular portion to be coated, and then sealant of a circular panel 300 can be coated by driving the rotation part 22 to rotate through the driving part. When a square sealant is required to be coated, the fixing stage 21 or the workbench 10 can be driven to move correspondingly.

For example, the above-mentioned embodiments collectively refer to a driving portion that drives the radial movement of the nozzle and the relative movement of the fixing stage and the workbench as the driving part, but the embodiments of the present disclosure are not limited thereto. For example, the driving part may include a first driving part that drives the nozzle to move radially, and a second driving part that drives the fixing stage and the workbench to move relatively. For example, in some embodiments, a first driving part is connected with the nozzle to drive the nozzle to move in a direction perpendicular to the rotation axis, to change a distance between the nozzle and the rotation axis. In some embodiments, a second drive part is connected with at least one of the fixing stage and the workbench to allow the fixing stage to be movable relative to the workbench in a first direction and a second direction, the first direction and the second direction being perpendicular to each other and both perpendicular to the rotation axis.

Therefore, it is not needed to achieve the coating of arc-shaped sealant through a combination of linear feedings in the conventional manner, and it is only need to directly align a center of the rotation part 22 with a center of the panel 300 to be coated and set the position of the nozzle 23, and the driving part drives the nozzle 23 to rotate to achieve the coating of the arc-shaped sealant. The driving part drives the fixing stage 21 and the workbench 10 to correspondingly move along the first direction X and/or the second direction Y to achieve the coating of square sealant.

To sum up, the present disclosure not only improves the contour shape accuracy of coated sealant, but also accelerates coating of a part of the coated sealant having a circular shape, thus improving utilization and productivity of apparatus. In addition, the programming of the apparatus is simplified, the preparation work is simplified, the production cycle is shortened, the production cost is reduced, and it is not needed to drive the same part to move in multiple directions at the same time, so that the sealant is easier to control and the problem of breakage in the coating process is not easy to occur.

It can be understood that, “the nozzle 23 is movable in the radial direction of the rotation axis” refers to that the distance between the nozzle 23 and the center of the rotation axis can be adjusted. That is, the distance between the nozzle 23 and the rotation axis is adjustable. However, a movement trajectory of the nozzle 23 is not limited to the radial direction, but may be any direction having an angle with the radial direction, as long as the distance between the nozzle 23 and the rotation axis can be adjusted.

In the coating apparatus 100 according to an embodiment of the present disclosure, the driving part includes a first driving motor 31 including a first motor body and a rotatable first output shaft, the first motor body is fixedly connected with the rotation part 22 and the first output shaft is connected with the nozzle 23, and the first output shaft is connected with the nozzle 23 through a transmission mechanism 24. For example, the first motor body of the first driving motor 31 is fixedly connected with the rotation part 22, the first output shaft is rotatable, and the transmission mechanism 24 connects the nozzle 23 with the first output shaft, the transmission mechanism 24 can convert rotation of the first output shaft into movement and drive the nozzle 23 to move in a corresponding direction.

As a result, a rotary motor and the transmission mechanism 24 are cooperatively used to achieve the movement and drive of the nozzle 23, which not only makes the movement more stable, but also has higher adjustment accuracy.

In the embodiment illustrated by FIG. 2, the transmission mechanism 24 is a lead screw nut mechanism. The lead screw nut mechanism includes a lead screw 241 and a nut 242 which are driven by threads. The lead screw 241 extends along a radial direction of the rotation part 22 and is connected with the first output shaft. The rotation part 22 is provided with a guide part 26 which is parallel to the lead screw 241. The nut 242 is in sliding connection with the guide part 26 and the nozzle 23 is fixedly connected with the nut 242. For example, in the embodiment according to the present disclosure, the rotation part 22 is not limited to a disk-shaped rotation part, but may be any suitable part that rotates around a rotation axis and is able to drive the nozzle to rotate around the rotation axis. Therefore, the radial extension direction of the lead screw 241 may be a direction perpendicular to the rotation axis.

Therefore, when an arc-shaped panel 300 with another radius of curvature is required to be coated, the first driving motor 31 is controlled to work. In this case, the output shaft of the first driving motor 31 rotates and drives the lead screw 241 connected with the first driving motor 31 to rotate together. The nut 242 which is driven through threads with the lead screw 241 moves along the radial direction under the rotating drive of the lead screw 241 and the guiding action of the guide part 26, and further drives the nozzle 23 fixedly connected with the nut 242 to move along the radial direction, thus achieving the adjustment of a position of the nozzle 23 from the center of the rotation axis. In addition, by controlling the first driving motor 31 to rotate forward or backward, the radius of curvature of an arc of the sealant coated by the nozzle 23 can be correspondingly increased or decreased to meet the coating requirements of different sizes of sealant.

In addition, the lead screw nut mechanism is adopted as the transmission mechanism 24, which has simple and compact structure, convenient processing and low costs.

In some embodiments, balls can also be arranged between the lead screw 241 and the nut 242, so that sliding friction screw is replaced by rolling friction screw, which has the advantages such as less wear, high transmission efficiency, stable transmission, long service life, high precision, low temperature rise, etc. Moreover, the rolling friction screw has outstanding advantages such as small motion friction and easy elimination of transmission gap, which brings great benefits to the performance improvement of electromechanical integration system.

Optionally, the nut 242 has a threaded hole for fitting with the lead screw 241 and a sliding hole for sliding fitting with the guide part 26, and the sliding hole is at least partially sleeved on the guide part 26. For example, the threaded hole and the sliding hole are arranged in parallel and spaced apart, so that the structure of the nut 242 is not only simpler and more compact, but also more convenient to process and low in costs.

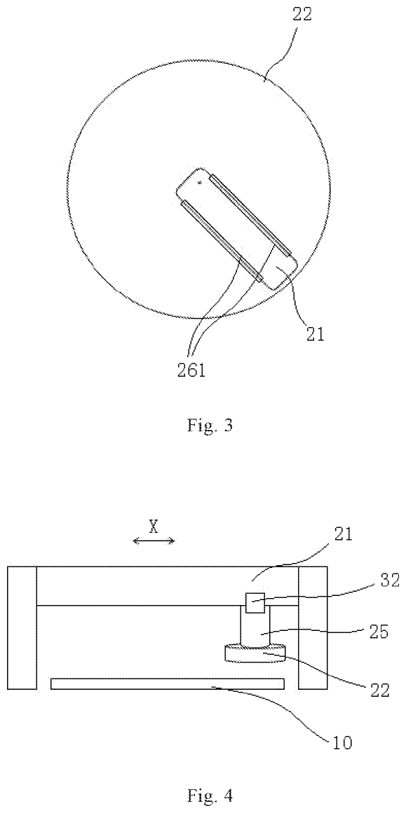

Furthermore, as illustrated by FIG. 3, the guide part 26 has a sliding groove 261, and a sliding rail is provided in the sliding hole. The sliding rail is clamped in the sliding groove 261 and is able to slide along the sliding groove 261. Therefore, the sliding of the nut 242 along the guide part 26 is more stable and reliable.

Of course, the present disclosure is not limited thereto. In other embodiments, the nut 242 may also be provided with an outwardly convex sliding rail, and the guide part 26 may be provided with a sliding groove 261 matched with the sliding rail.

Optionally, the coating apparatus 100 further includes a control element electrically connected to the first driving motor 31 to control startup and shutdown of the first output shaft. The guide part 26 is an optical scale which is configured to read position information of the nozzle 23 in real time and sends the position information to the control element. As a result, the guide part 26 can not only guide the movement of the nozzle 23, but also read the position information of the nozzle 23 in real time to make the positioning of the nozzle 23 more accurate, further enhancing the accuracy of coating sealant.

The transmission mechanism 24 is not limited to the lead screw nut mechanism of the above-mentioned embodiment, but may also be other transmission mechanisms 24 capable of converting rotational motion into linear motion, for example, the transmission mechanism 24 is a rack-pinion transmission mechanism 24 or a crank-slider mechanism.

For example, in some embodiments, the transmission mechanism 24 is a rack-pinion mechanism including a pinion and a rack which are engaged with each other, the pinion is connected with the first output shaft, the rack extends in the radial direction of the rotation part 22, the rack are in sliding connection to the guide part 26, and the nozzle 23 is fixedly connected to the racks.

In this way, when an arc-shaped panel 300 with another radius of curvature is required to be coated, the first driving motor 31 is controlled to work. In this case, the first output shaft rotates and drives the pinion connected with the first output shaft to rotate together, the rack is engaged with the pinion and moves along the radial direction under the guidance of the guide part 26, and then drives the nozzle 23 fixedly connected with the rack to move along the radial direction, thus achieving the adjustment of the position of the nozzle 23 from the center of the rotation axis.

In still other embodiments, the transmission mechanism 24 is a crank-slider mechanism including a crank and a slider which are engaged with each other, the crank is connected with the first output shaft, the slider extends in the radial direction of the rotation part 22, the slider is in sliding connection with the guide part 26, and the nozzle 23 is fixedly connected with the slider. Thus, the position adjustment of the nozzle 23 can also be achieved by the crank-slider mechanism, thereby satisfying the coating of panels 300 of different sizes.

In the example illustrated by FIG. 4, the fixing stage 21 is further provided with a work head 25 which is movable in a first direction X, the rotation part 22 is formed as a rotating working disc, a center of the rotation part 22 is connected with the work head 25, and the driving part further comprises a second driving motor 32 and a third driving motor (not shown in the figure), the second driving motor 32 includes a second motor body and a movable second output shaft, the second motor body is fixedly connected with the fixing stage 21 and the second output shaft is connected with the work head 25 to drive the work head 25 to move along the first direction X. The third driving motor includes a third motor body and a rotatable third output shaft, the third motor body is fixedly connected with the work head 25 and the third output shaft is connected with the rotation part 22 to drive the rotation part 22 to rotate.

Therefore, the present disclosure can not only directly drive the work head 25 to move through the second driving motor 32 to achieve the movement of the rotation part 22 and the nozzle 23 in the first direction X as a whole, but also drive the pivoting movement of the rotating disc on the work head 25 through the third output shaft of the third driving motor to achieve the coating of a circular part, so that the movement of the nozzle 23 is more stable, and the movable work head 25 is arranged to achieve the coating of other linear parts except rectangles.

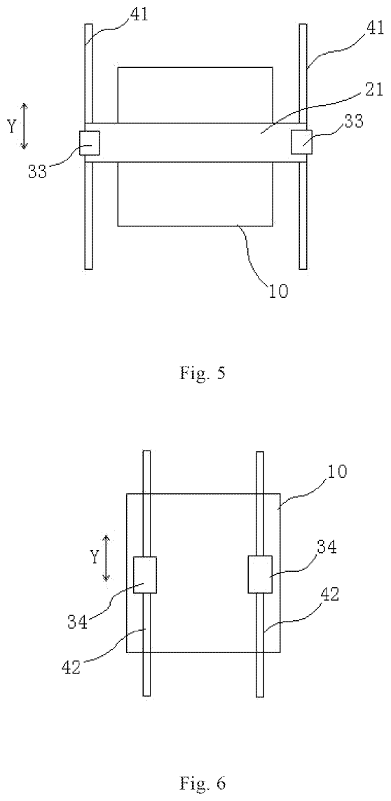

As illustrated by FIG. 5, the fixing stage 21 is configured to be movable in the second direction Y, the driving part further includes a fourth driving motor 33 including a fourth motor body and a movable fourth output shaft, the fixing stage 21 is a bar-shaped stage extending in the first direction X, both ends of the fixing stage 21 are respectively provided with a first guide rail 41 extending in the second direction Y perpendicular to the fixing stage 21, the fixing stage 21 is in sliding connection with the first guide rail 41, and the fourth output shaft is connected with the fixing stage 21 to drive the fixing stage 21 to move. As a result, the fixing stage 21 can be driven to slide along the second direction Y on the first guide rail 41 by the fourth output shaft of the fourth driving motor 33, so as to achieve the coating of the sealant along the second direction Y or the coarse positioning of the nozzle 23.

Similarly, the workbench 10 can be configured to move along the first direction X or the second direction Y to facilitate rectangular coating. For example, as illustrated by FIG. 6, the workbench 10 is configured to be movable in the second direction Y, the driving part further includes a fifth driving motor 34 including a fifth motor body and a fifth output shaft, a back surface of the workbench 10 is provided with a second guide rail 42, the workbench 10 is in sliding connection with the second guide rail 42, and the fifth output shaft is connected with the workbench 10 to drive the workbench 10 to move. In this way, the fifth driving motor 34 can drive the workbench 10 to slide along the second direction Y on the second guide rail 42 to make up for the defect of limited moving range of the spraying part and further expand the coating range of the coating apparatus 100.

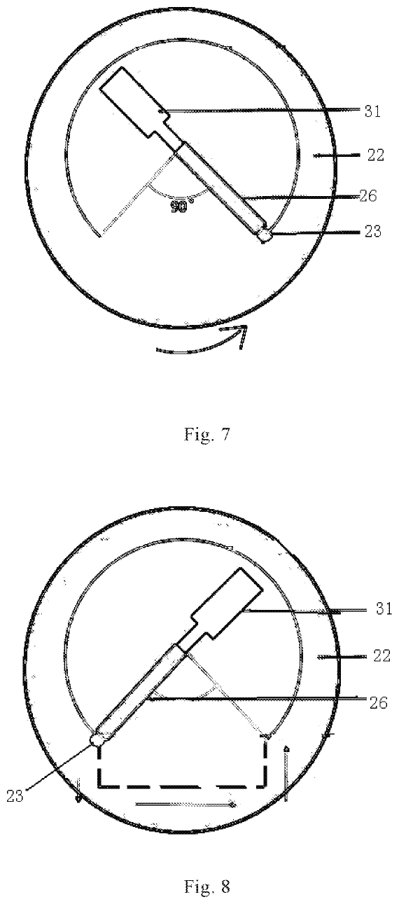

The operation of the coating apparatus 100 according to an embodiment of the present disclosure will be briefly described below with reference to FIGS. 7 and 8.

Step 1: the second driving motor 32 is controlled to operate to make the work head 25 lock a center coordinates of a circle portion of an irregular shape panel 300. For example, an extension line of the rotation axis of the rotation part passes through the center of the circle. After the positioning is completed, the first driving motor 31 is controlled to operate to make the nozzle 23 move in the radial direction under the push of the transmission mechanism 24 to achieve the position adjustment of the nozzle 23 in the radial direction.

After that, the third driving motor is controlled to operate to drive the rotating disk to rotate for a preset number of turns (e.g., the rotating disk rotates 270 degrees counterclockwise), thereby completing the coating of the circular portion of the panel 300.

Step 2: after step 1 is completed, the nozzle 23 is located at the position illustrated by FIG. 7. At this time, the third driving motor stops working and the rotating disc stops rotating. As illustrated by FIG. 8, the relative movement between the work head 25 and the workbench 10 is controlled to achieve the coating of the sealant in the first direction X and the second direction Y, thus completing the coating of each side of a rectangular frame.

The operation of the coating apparatus 100 described above is merely exemplary. Through the coating apparatus of the embodiment of the disclosure, circular coating and linear coating can be achieved. Of course, circular coating and linear coating can be combined to achieve coating of more complex shapes if necessary.

In the description of the present disclosure, it is to be understood that the azimuth or positional relationships indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” and the like are azimuth or positional relationships illustrated by the drawings. It is only for the convenience of describing the present disclosure and simplifying the description, and is not intended to indicate or imply that the structures or elements referred to must have a specific orientation, be constructed and operate in a specific orientation, and therefore should not be construed as limiting the present disclosure. In addition, portions defining “first” and “second” may include one or more of the portions explicitly or implicitly. In the description of the present disclosure, unless otherwise defined, “a plurality of” refers to two or more.

In the description of this specification, the description referring to the terms “an embodiment”, “some embodiments”, “exemplary embodiments”, “examples”, “specific examples” or “some examples” and the like refers to that a specific portion, structure, material, or characteristic described in connection with the embodiment or example is included in at least one embodiment or example of the present disclosure. In this specification, the schematic representation of the above-mentioned terms does not necessarily refer to the same embodiment or example. Furthermore, specific portions, structures, materials or features described may be combined in any one or more embodiments or examples in a suitable manner.

The forgoing is merely an exemplary embodiment of the present disclosure and is not intended to limit the protection scope of the present disclosure, and the protection scope of the present disclosure is determined by the appended claims.

1. A coating apparatus, comprising:
a nozzle, having a spraying direction; and
a rotation part, having a rotation axis, the rotation part being connected with the nozzle to drive the nozzle to rotate around the rotation axis,
wherein the spraying direction and an extension direction of the rotation axis are not perpendicular to each other.

2. The coating apparatus according to claim 1, wherein the nozzle is movably connected with the rotation part to allow a distance between the nozzle and the rotation axis to be adjustable.

3. The coating apparatus according to claim 1 or 2, wherein the spraying direction is parallel to the extending direction of the rotation axis.

4. The coating apparatus according to claim 2, further comprising:
a fixing stage, the rotation part being connected with the fixing stage.

5. The coating apparatus according to claim 4, further comprising:
a workbench, comprising a bearing surface for bearing a piece to be coated, and the rotation axis of the rotation part being perpendicular to the bearing surface of the workbench.

6. The coating apparatus according to claim 1, further comprising:
a first driving part, connected with the nozzle to drive the nozzle to move in a direction perpendicular to the rotation axis, so as to change the distance between the nozzle and the rotation axis.

7. The coating apparatus according to claim 5, further comprising:
a second driving part, connected with at least one of the fixing stage and the workbench to allow the fixing stage to be movable relative to the workbench in a first direction and a second direction, the first direction and the second direction being perpendicular to each other and both perpendicular to the rotation axis.

8. The coating apparatus according to claim 6, wherein the first driving part comprises a first driving motor, the first driving motor comprises a first motor body and a rotatable first output shaft, the first motor body is fixedly connected with the rotation part, and the first output shaft is connected with the nozzle through a transmission mechanism.

9. The coating apparatus according to claim 8, wherein the transmission mechanism is a lead screw nut mechanism, the lead screw nut mechanism comprises a lead screw and a nut which are driven through threads, the lead screw extends in a direction perpendicular to the rotation axis and is connected with the first output shaft, the rotation part is provided with a guide part extending in a direction perpendicular to the rotation axis, the nut is in a sliding connection with the guide part, and the nozzle is fixedly connected with the nut.

10. The coating apparatus according to claim 9, wherein the nut has a threaded hole for fitting with the lead screw and a sliding hole for fitting with the guide part, and the sliding hole is at least partially sleeved on the guide part.

11. The coating apparatus according to claim 10, wherein the guide part has a sliding groove, the sliding hole is provided with a sliding rail therein, and the sliding rail being clamped into the sliding groove and being able to slide along the sliding groove.

12. The coating apparatus according to claim 8, wherein the transmission mechanism is a rack-pinion mechanism, and the rack-pinion mechanism comprises a pinion and a rack which are engaged with each other, the pinion is connected with the first output shaft, the rack extends in a direction perpendicular to the rotation axis, the rotation part is provided with a guide part extending in a direction perpendicular to the rotation axis, the rack is in sliding connection with the guide part, and the nozzle is fixedly connected with the rack.

13. The coating apparatus according to claim 8, wherein the transmission mechanism is a crank-slider mechanism, and the crank-slider mechanism comprises a crank and a slider which are engaged with each other, the crank is connected with the first output shaft, the slider extends in a direction perpendicular to the rotation axis, the rotation part is provided with a guide part extending in a direction perpendicular to the rotation axis, the slider is in sliding connection with the guide part, and the nozzle is fixedly connected with the slider.

14. The coating apparatus according to claim 9, further comprising a control element electrically connected to the first driving motor to control startup and shutdown of the first output shaft, the guide part being an optical scale, which is configured to read position information of the nozzle in real time and send the position information to the control element.

15. The coating apparatus according to claim 7, wherein the fixing stage is further provided with a work head, the rotation part is a rotation work disk, a center of the rotation part is connected with the work head, and the second driving part comprises:
a second driving motor comprising a second motor body and a movable second output shaft, wherein the second motor body is fixedly connected with the fixing stage and the second output shaft is connected with the work head to drive the work head to move in the first direction; and
a third driving motor comprising a third motor body and a rotatable third output shaft, wherein the third motor body is fixedly connected with the work head and the third output shaft is connected with the rotation part to drive the rotation part to rotate.

16. The coating apparatus according to claim 7, wherein the fixing stage is configured to be movable in the second direction, the second driving part further comprises a fourth driving motor, the fourth driving motor comprises a fourth motor body and a movable fourth output shaft, the fixing stage is a bar-shaped stage extending in the first direction, both ends of the fixing stage are respectively provided with a first guide rail perpendicular to the fixing stage and extending in the second direction, the fixing stage is in sliding connection with the first guide rail, and the fourth output shaft is connected with the first guide rail to drive the fixing stage to move.

17. The coating apparatus according to claim 7, wherein the workbench is configured to be movable in a second direction, and the driving part further includes a fifth driving motor comprising a fifth motor body and a movable fifth output shaft, a back surface of the workbench is provided with a second guide rail, the workbench is in sliding connection with the second guide rail, and the fifth output shaft is connected with the workbench to drive the workbench to move.

18. The coating apparatus according to claim 2, wherein the spraying direction is parallel to the extending direction of the rotation axis.

19. The coating apparatus according to claim 2, further comprising:
a first driving part, connected with the nozzle to drive the nozzle to move in a direction perpendicular to the rotation axis, so as to change the distance between the nozzle and the rotation axis.

20. The coating apparatus according to claim 10, further comprising a control element electrically connected to the first driving motor to control startup and shutdown of the first output shaft, the guide part being an optical scale, which is configured to read position information of the nozzle in real time and send the position information to the control element.
